(19) United States
(12) Patent Application Publication
(10) Pub. No.: US 2012/0150971 A1
(43) Pub. Date: Jun. 14, 2012

(54) PRESENTING NOTIFICATIONS OF CONTENT ITEMS SHARED BY SOCIAL NETWORK CONTACTS

(75) Inventors: Shazaan Bahrainwala, Seattle, WA (US); Wissam Kazan, Redmond, WA (US); Amanda Font, Kirkland, WA (US); Mona Akmal, Bellevue, WA (US); Francislav P. Penov, Kirkland, WA (US); Patrick Jakubowski, Seattle, WA (US); Benjamin Nicholas Truelove, Lynnwood, WA (US); Vasudha Chandrasekaran, Kirkland, WA (US)

(73) Assignee: Microsoft Corporation, Redmond, WA (US)

(21) Appl. No.: 12/966,597

(22) Filed: Dec. 13, 2010

(51) Int. Cl. G06F 15/16

(52) U.S. Cl. 709/206

(57) ABSTRACT

Within a social network, a user may establish a set of contacts who share with the user various content items and comments related thereto. However, these content items are often hosted by a content source outside of the social network, and the user may have to transition to the content source to view the content item, and then transition back to the social network to submit a comment. Instead, a device may monitor the social network to record shared content items. When the user requests a presentation of the content source, notifications of the content items hosted by the content source that have been shared with the user, including an identifier of the contact sharing the content item with the user (e.g., a depiction or avatar representation of the contact and a link to a social profile of the contact) may be included in the presentation.

### BACKGROUND

Within the field of computing, many scenarios involve a social network, such as a database of users and associations established thereamong to represent various types of relationships (e.g., familial relations, friendships, and academic, professional, and business relationships). A user within a social network may establish a set of contacts, such as individuals with whom the user has a relationship, and may add new individuals as new relationships are formed. The social network may enable users to share with his or her contacts within the social network various types of messages, such as personal status messages. The social network may also allow a user to view the messages shared with the user by his or her contacts, such as a news feed comprising the personal status messages of the user's contacts.

Within a social network, a user may share with his or her contacts one or more content items hosted by various content sources. Such content items and content sources may include, e.g., web pages hosted by a website, images hosted by an image database, audio or video recordings hosted by an audio or video sharing service, and files hosted by a file server. A user may share these content items with his or her contacts in many ways, e.g., by adding an item to a set of shared content items that are of interest to the user and that may be viewable by all contacts of the user, or by sending a message to a contact that references a content item. The user may also annotate the content item with a comment, such as a summary of the content item or the user's personal opinions of the content item, and his or her contacts may also be permitted to annotate the content item with comments. The social network may promote this sharing of content items by generating a presentation thereof; e.g., upon request of a user, the social network may generate a content item feed comprising the content items that have been shared with the user by his or her contacts. For a particular content item hosted by a content source (e.g., an image hosted by an image database), the social network may be configured to integrate the content item with the presentation, or to provide a reference to the content item hosted by the content source (e.g., a preview version of an image hosted by the image database, and a hyperlink to an area of the image database where a full version of the image may be viewed).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A user of a social network may find that many contacts are sharing content items with the user. For example, the content items shared with the user of a social network may include content items sent by contacts of the user in private messages; content items that are posted by a contact on a public message portion of the social profile of the user; content items posted on a public message portion of the social profile of a contact; and references to content items that are included in personal status messages of a contact. Accordingly, the user may have difficulty tracking the sharing of content items. For example, for some of these content items, the user may have to view the content item outside of the social network, e.g., by visiting the content source and requesting the content item. However, even if several content items hosted by the same content source are shared with the user in a particular social network, the user may be unable to identify the content items shared with the user within the content source. Rather, the user may have to return to the social network in order to identify the content items hosted by the content source that have been shared with the user by one or more contacts within the social network. This navigation leads to inefficiency and one or more transitions in the domain viewed by the user that disrupt the smooth user experience. This scenario may become even more disjointed if the user belongs to several social networks, such that content items may be shared with the user by contacts from several social networks, resulting in an undesirable distribution of shared content items across several social networks and many content sources. Additionally, a contact may have a social profile within a social network that is recognizable by the user (e.g., a familiar name, username, or depiction, such as a photo or avatar representation), but this social profile may not be shared with the content source. Accordingly, when the user views a content item within a content source, the content source may be unable to provide sufficient information to identify for the user the contact who has shared the content item with the user.

Instead, and in accordance with the techniques presented herein, the user experience of the user may be improved if the user, while visiting a content source, may identify the content items hosted by the content source and that have been shared with the user by a contact within the social network. In accordance with these techniques, a device may be configured to retrieve content items shared with the user within the social network(s). When the user visits a content source (such as a website, an image database, an audio or video sharing service, or a file server), the device may retrieve the content items that are hosted by the content source and that have been shared with the user by a contact within a social network 12. Notifications of the content items so retrieved (e.g., a list of the titles of the content items and hyperlinks to respective presentations of the content items within the content source) may be included in a presentation of the content source to the user, along with an indication of the contact(s) who shared the content item with the user within the social network. This indication may be based on the social profile of the contact within a social network, which may be familiar to the user.

As an exemplary application of these techniques, if a user visits an image database, a device may identify the set of images that are hosted by the image database and that one or more contacts of the user within the social network have shared with the user. The device may then supplement the presentation of the image database with a list of references to the content items hosted by the image database that have been shared with the user by a contact within the social network, including an indication of each contact who shared the content item with the user within a social network (e.g., a name or nickname of the contact, a depiction of the contact, such as a photo or an avatar representation, and/or a reference to a social profile of the contact within a social network). In this manner, these techniques may improve the integration of content sources with one or more social networks by reducing the distracting transitions of the user between content sources and the social network.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring users of a social network sharing and viewing content items hosted by content sources and shared within the social network.

FIG. 2 is an illustration of an exemplary scenario featuring a device configured to retrieve content items respectively hosted by a content source and shared with a user within a social network in accordance with the techniques presented herein.

FIG. 3 is an illustration of an exemplary scenario featuring a presentation of content items hosted by a content source and shared with a user of a social network in accordance with the techniques presented herein.

FIG. 4 is an illustration of another exemplary scenario featuring a presentation of content items hosted by a content source and shared with a user of a social network in accordance with the techniques presented herein.

FIG. 5 is a flow chart illustrating an exemplary method of presenting content items shared with a user within a social network in accordance with the techniques presented herein.

FIG. 6 is a component block diagram illustrating an exemplary system for presenting content items shared with a user within a social network.

FIG. 7 is a flow chart illustrating another exemplary method of presenting content items shared with a user within a social network.

FIG. 8 is a component block diagram illustrating another exemplary system for presenting content items shared with a user within a social network.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a social network comprising a representation of a set of individuals and relationships thereamong. Such relationships may represent, e.g., familial relations, friendships, shared membership in a group or activity, or academic or professional relationships. The social network may permit a user to establish a set of contacts with whom the individual shares a relationship. The users of the social may then exchange messages with one or more contacts, such as public status messages that may be viewed by all contacts of the user, public or private messages sent to one or more contacts, or chat messages exchanged in a realtime chat environment.

A social network also allows a user to share one or more content items with other users, such as documents, images, audio and video recordings, and executable applications. In some scenarios, the user may upload the content item to the social network, which may store the content item and may present a copy of the content item to contacts who request access to the content item. In other scenarios, the user may provide a reference to a content item hosted by a content source outside of the social network, such as a web page of a website, an image of an image repository, an audio or video recording hosted by an audio or video repository, or a file hosted by a file sharing service. In these cases, the user may provide a reference to the content item shared by the content source, such as a uniform resource identifier (URI) within the domain of the content source. The social network may allow the user to share the reference to one or more contacts, who may use the reference (such as clicking on a hyperlink associated with the URI of the content item) in order to view the content item in the context of the content source (e.g., by navigating to the web page of the content source where the content item is presented). The user and his or her contacts may also submit comments in response to the content item and/or in response to other comments to the content item. Such comments may either be posted at the content source (e.g., within the web page of a website of the content source) or within the social network (e.g., associated with the reference shared by the user).

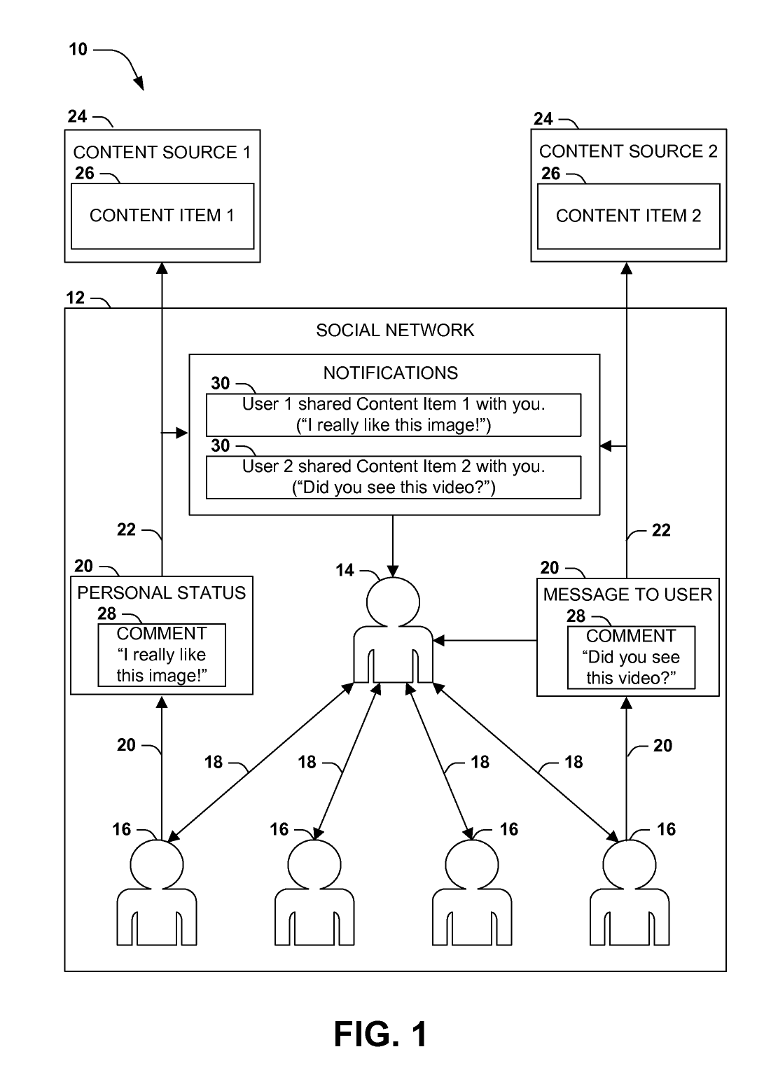

FIG. 1 presents an exemplary scenario 10 featuring a social network 12 comprising a user 14 who has established a set of relationships 18 with a set of contacts 16. The relationships 18 may represent, e.g., real-world familial relationships, friendships, academic or professional associations, shared membership in an organization, or shared traits or interests in a particular online or offline activity. Within the social network 12, various contacts 16 having a relationship 18 with the user 14 may generate one or more messages 20 involving a reference to a content item 26 hosted by a content source 24. For example, a first contact 16 having a relationship 18 with the user 14 may author a first message 20 comprising a personal status message that is viewable by anyone having a relationship 18 with the first contact 16, including the user 14, wherein the personal status message includes a reference 22 to a first content item 26 hosted by a first content source 24. The first contact 16 may also include in the first message 20 a comment 28 about the first content item 26. This first comment 28 may be stored by the social network 12 and displayed with the reference 22 when the user 14 requests to view the first message 20. Similarly, a second contact 16 having a relationship 18 with the user 14 may author a second message 20 comprising a public or private message addressing the user 14 This personal or private message includes a reference 22 to a second content item 26 hosted by a second content source 24. The second contact 16 may also include in the second message 20 a comment 28 about the second content item 26, which may be stored by the social network 12 and displayed with the reference 22 when the user 14 requests to view the second message 20. The social network 12 may then notify the user 14 of the shared content items by preparing and presenting to the user 14 a set of notifications, such as a first notification 30 indicating the sharing by the first contact 16 of the first content item 26 (possibly including the comment 28 associated therewith) and a second notification 30 indicating the sharing by the second contact 16 of the second content item 26 (possibly including the comment 28 associated therewith).

In the manner illustrated in the exemplary scenario 10 of FIG. 1, some social networks 12 and content sources 24 may facilitate the sharing of content items 26 within the social network 12 and the notification of the user 14 of such sharing. However, several disadvantages may be apparent within this exemplary scenario 10. As a first example, in order to view a particular content item 26 shared within the social network 12, the user 14 may have to navigate from the domain of the social network 12 to the domain of the content source 24 (e.g., by clicking a hyperlink provided within the social network 12 to view a different web page within the content source 24 where the content item 26 is presented), and may then have to navigate back to the domain of the social network 12. These domain transitions may be distracting, and may disrupt a smooth user experience. As a second example, while the user 14 is visiting the content source 24, a contact 16 of the user 14 may share within the social network 12 a content item 26 that is hosted by the content source 24. However, the news of the sharing may be retained by the social network 12, and may not be sent to either the content source 24 or to the device operated by the user 14. Consequently, the user 14 may not be notified of the sharing of the content item 26 while visiting the content source 24. Rather, upon returning to the social network 12, the user 14 may receive a notification 30 of the shared content item 26, and may have to return to the content source 24 to view the recently shared content item 26. The lack of interoperation among the social network 12, the device of the user 14, and the content source 24 thereby causes several unnecessary transitions among domains that disrupt the smooth user experience of the user 14.

These disadvantages may be exacerbated in more complex scenarios. As a first example, the user 14 may belong to several social networks 12, and many contacts 16 within the various social networks 12 may share content items 26 with the user 14. However, in some scenarios, the user 14 cannot receive news of the shared content items 26 until visiting each social network 12 in turn. This complexity may be further enhanced by differences in user interfaces among the social networks 12 and/or content sources 24. For example, content items 26 may be presented in a different visual manner in each location, leading to frequent transitions in the aesthetics presented by the different domains. As a second example, a contact 16 may have a social profile in a social network 12 that is recognizable by the user 14, but this social profile may not be shared with the content source 24. Accordingly, the content source 26 may identify the contact 16 in a different manner (e.g., according to a different account name), or may not present any identification of the contact 15 in association with the content item 26. Thus, while viewing the content item 26 at the content source 26, the user 14 may be unable to determine the contact 16 who has shared the content item 26 with the user 14. These complexities may impose significant inefficiencies in the user experience of a user 14 endeavoring to receive notifications of shared content items 26.

Presented herein are techniques for improving the consistency of the user experience of a user 14 while interacting with a content item 26 hosted by a content source 24 and shared with the user 14 by a contact 16 within a social network 12. In accordance with these techniques, a device may track the sharing of content items 26 with the user 14 (e.g., references to content items 26 posted within personal status messages of contacts 16 of the user 14, in public and private messages 20 addressing the user 14, and in chat messages sent to the user 14), as well as the content source 24 hosting the respective content items 26. However, the content items 26 shared with the user 14 (as well as comments 28 thereto) may be numerous and varied, so the presentation of notifications of an aggregated stream of content items 26 may be voluminous and/or haphazard (e.g., a jumbled collection of documents, images, audio and video recordings, and files). It may be desirable to narrow the presentation of shared content items 26 to those that are similar to another content item 26 that the user 14 is currently viewing. In particular, it may be desirable to detect when the user 14 is requesting a presentation of a content source 24, and to integrate with the presentation of the content source 24 the notifications 30 of content items 26 that are hosted by the content source 24, and that one or more contacts 16 of the user 14 have shared with the user 14 within the social network 12. In addition to reducing the number of notifications 30 presented for shared content items 26, this technique also notifies the user 14 of recently shared content items 26 within a presented content source 24, thereby reducing the transitions of domains viewing a content source 24 and a social network 12 and thus improving the smoothness of the user experience of the user 14. Moreover, by identifying the contact 16 sharing a content item with the user 14 within the notification 30 presented in the content source 24 (e.g., according to one or more aspects of the social profile of the contact 16 within the social network 12), an embodiment of these techniques may improve the relevance of the notifications 30 to the user 14.

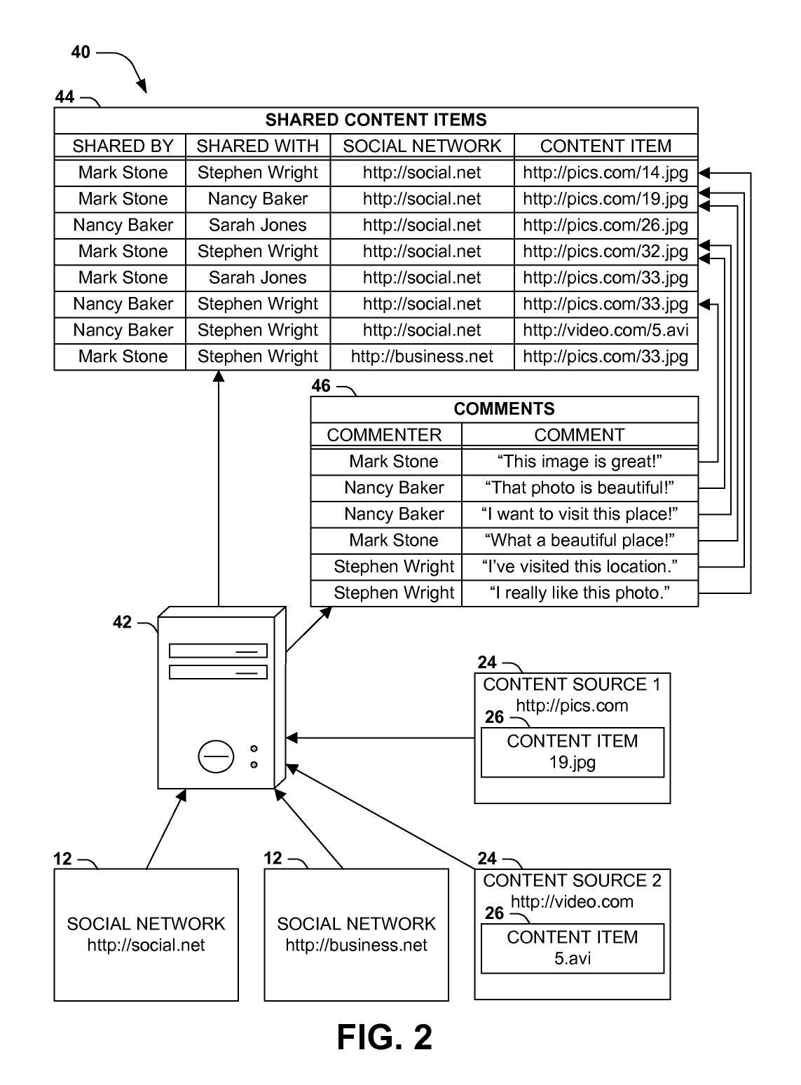

FIG. 2 presents an exemplary scenario 40 featuring a device 42 configured to monitor one or more social networks 12 in order to detect a sharing within the social network 12 of one or more content items 26 with a user 14. In accordance with these techniques, a device 42 may be configured to access the social networks 12, e.g., in a push manner (such as where the social networks 12 actively notify the device 42 when a contact 16 shares a content item 26 with the user 14) and/or in a pull manner (such as by configuring the device 42 to, on a periodic basis, retrieve the content items 26 shared by one or more contacts 16 with the user 14). The monitoring of the content items 26 may include the monitoring and retrieval of comments 28 associated therewith. The device 42 may record such detected content items 26 and comments 28, as well as the content sources 24 hosting these content items 26. For example, the device 42 may generate a content item data set 44 (such as a table in a relational database) recording, for various instances of a content item 26 by a contact 16 with a user 24, the identities of the entities sharing the content item 26 and with whom the content item 26 has been shared, and a reference 22 to the content item 26 including an indicator of the content source 24 hosting the content item 26. The device 42 may also store, e.g., an indicator of the social network 12 within which the instance of the sharing occurred. The device 42 may also record, in a comment data set 46 (or, alternatively, in the content item data set 42), the comments 28 submitted with respect to the content items 26 (either directly in response to a content item 26 or in response to another comment 28). The device 42 may maintain these records of the shared content items 26 and contents 28 when a user 14 requests a presentation of a content source 24.

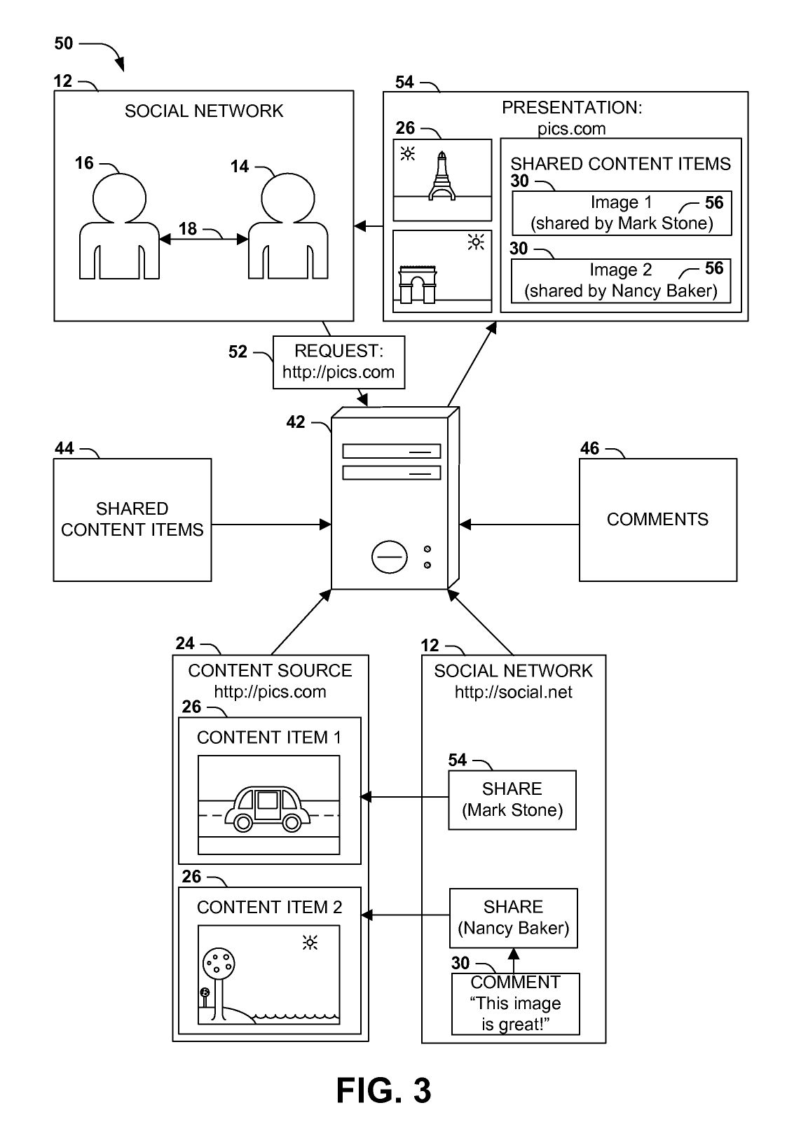

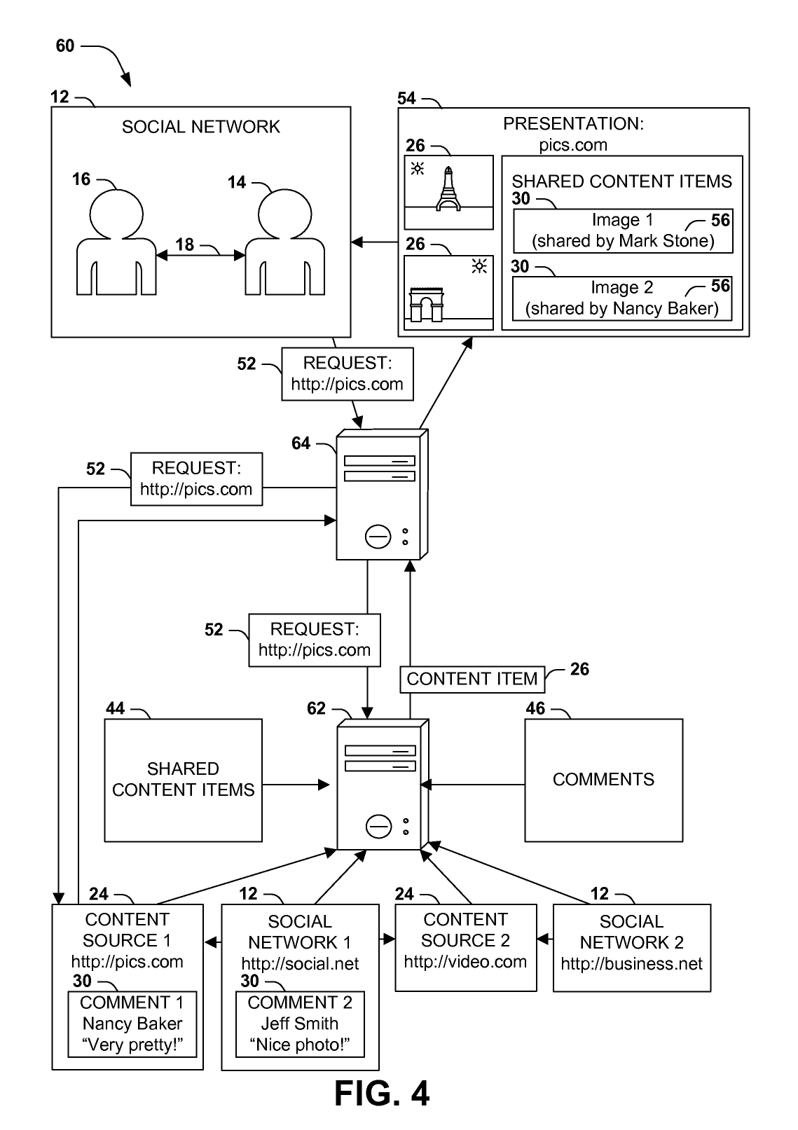

The information gathered in the exemplary scenario 40 of FIG. 2 may be used in various ways. FIGS. 3 and 4 present two exemplary scenarios featuring two similar, but alternative, uses of this information, but those of ordinary skill in the art may devise other uses that are compatible with the techniques presented herein.

FIG. 3 presents a first exemplary scenario 50 of the techniques presented herein, wherein a user 14 may submit to a device 42 a request 52 for a presentation 54 of a content source 24, e.g., by navigating to the content source 24 in a web browser. The device 42 may comprise, e.g., an additional configuration of the device 42 in the exemplary scenario 40 of FIG. 2, such as a client-operated device that both monitors the social networks 12 and that presents content sources 24 to the user 14 upon request. The device 42 may therefore accept the request 52 and may examine the records indicating the shared content items 26 and/or comments 28 gathered in the exemplary scenario 40 of FIG. 2. For example, if the user 14 submits a request 52 for a presentation 54 of the content source 24 accessible at the URI “http://pics.com”, the device 42 may search the content item data set 44 for content items 26 shared with the user 14 within the social network 12 and hosted by this content source 24 (e.g., featuring a reference 22 that includes this URI). The device 42 may then generate a presentation 54 of the content source 24, e.g., by contacting the content source 24 as requested by the user 14, by rendering a web page based on the web components sent by the content source 24, and by displaying for the user 14 the rendered web page in a web browser. In accordance with the techniques presented herein, the device 42 may include in the presentation 54 of the content source 24 one or more notifications 30 of content items 26 that are hosted by the content source 24 and that have been shared with the user 14 by a contact 16 within a social network 12. For example, for a content source 24 comprising an image database, the user 14 may submit a URI associated with a particular image that the user 14 wishes to view. The device 42 may detect the content source 24, and by searching the content item data set 26 may identify other images hosted by the image database that have been shared with the user 14 within the social network 12. The device 42 may therefore include in the presentation 54 of the content source 24 notifications 30 of respective shared content items 26, such as a name of the shared content item, a description or summary of the content item, and/or a reference 22 to the content item 26, such as a uniform resource identifier (URI) of a web page within the content source 24 where the shared content item 26 may be viewed. The notifications 30 may also identify the contact 16 who has shared the content item 26 with the user 14 within the social network 12. This identification may be achieved, e.g., by including in the notification 30 a contact identifier 56, such as a name or nickname of the contact 16, a photo or avatar representation, or a reference 22 to a social profile of the contact 16 (e.g., a uniform resource identifier (URI) associated with the social profile of the contact 16 within the social network 12). Additionally, the device 42 may, by searching the comment data set 46, present comments 28 associated with the shared content items 26. In this manner, the device 42 may assist the user 14 in receiving notifications 30 of shared content items 26, including the identity of the contact 16 who has shared the content item 26 with the user 14, without having to leave the content source 24.

FIG. 4 presents a second exemplary scenario 60 of the techniques presented herein, wherein a user 14 may submit a request 52 for a presentation 54 of a content source 24, e.g., by navigating to the content source 24 in a web browser. In accordance with the techniques presented herein, and in a similar manner as illustrated in the first exemplary scenario 50 of FIG. 3, the content item data set 44 may be examined to retrieve content items 26 that are hosted by the same content source 24 and that have been shared with the user 14 within a social network 12. However, this second exemplary scenario 60 of FIG. 4 differs from the first exemplary scenario 50 of FIG. 3 in a few key aspects. As a first example, a content item server 62 may be configured to monitor the social network 12 and to record the sharing of content items 26 (e.g., by generating the content item data set 44 and the comment data set 46). This content item server 62 may comprise, e.g., one or more servers that are dedicated to this monitoring and recording on behalf of a potentially large number of users 14 of the social network 12. Additionally, a particular user 14 may operate a client 64 (such as a personal computer or a mobile phone) that is configured to receive from the user 14 the request 52 for a presentation 54 of a content source 24. The client 64 may be configured to forward the request 52 to the content item server 62, which may notify the client 64 of the content items 26 hosted by the same content source 24 that have been shared with the user 14 within a social network 12 (possibly including the comments 28 related thereto). The client 64 may then receive these content items 26 and may insert into the presentation 54 of the content source 24 one or more notifications 30 of shared content items 26, including a contact identifier 56 that identifies the contact 16 who has shared the content item 26 with the user 14.

While the second exemplary scenario 60 in FIG. 4 is more complex than the first exemplary scenario 50 of FIG. 3, this second exemplary scenario 60 may present distinct advantages. For example, by configuring the monitoring in a separate content item server 62 that is separate from the client 64 operated by the user 14, this architecture may present higher scalability to service a larger body of users 14 and/or to monitor a wider set of social network 12. This architecture may also reduce the cost of monitoring the social network 12 (since the content item server 62 may monitor the social network 12 on behalf of many users 14, instead of each user 14 operating a different device 42 that monitors the social network 12). Additionally, in this exemplary scenario 60, the content item server 62 is configured to monitor a plurality of social networks 14; e.g., a user 14 may belong to a first social network 14 to establish casual relationships 18 such as familial relationships and friendships, and a second social network 14 to establish professional relationships 18 such as academic and business connections. By monitoring several social networks 14, the content item server 62 may aggregate the notifications 30 of shared content items 26 to the user 14, e.g., by including within a presentation 54 of a content source 24 the notifications 30 of content items 26 hosted by the content source 24 and shared with the user 14 within many social networks 14, thereby further reducing transitions between domains (e.g., as opposed to the user 14 having to visit several social networks 12 in order to receive the notifications 30) and further improving the smooth user experience of the user 14.

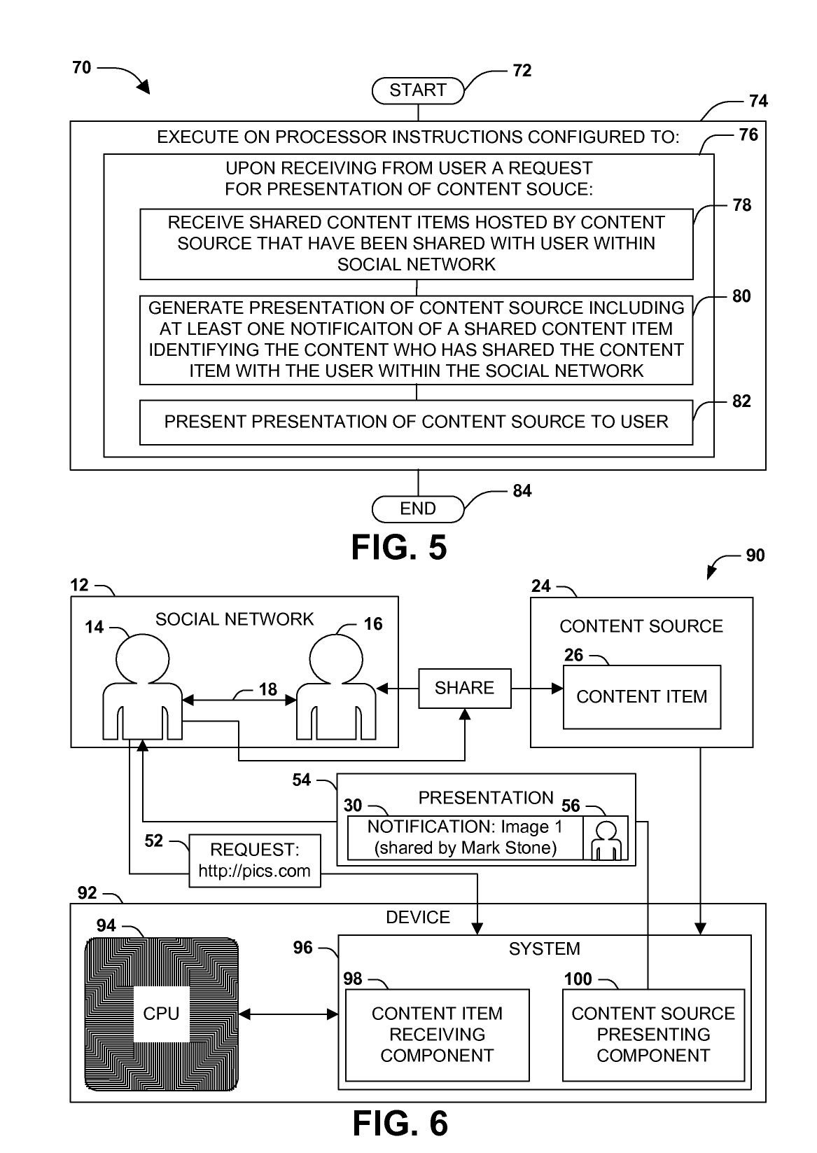

FIG. 5 presents a first embodiment of these techniques, illustrated as an exemplary method 70 of notifying a user 14 of content items 26 shared by a contact 16 within a social network 12. This exemplary method 70 may be implemented, e.g., as a set of software instructions stored in a memory component of a device 42, such as a system memory circuit, a platter of a hard disk drive, a solid-state storage device, or a magnetic or optical disc, where such instructions are configured to implement the techniques presented herein. This exemplary method 70 begins at 72 and involves executing 74 the instructions on a processor of the device 42. In particular, the instructions may be configured to, upon receiving from the user 14 a request 52 for a presentation 54 of a content source 24, receive 76 shared content items 26 that are hosted by the content source 24 and that have been shared with the user 14 within the social network 12 (possibly including the comments 28 associated with such content items 26). The instructions are also configured to, upon receiving 78 from the user 14 a request 52 for a presentation 54 of a content source 24, generate 80 a presentation 54 of the content source 24 including at least one notification 30 of a content item 26 shared with the user 14 and identifying the contact 16 sharing the content item 26 with the user 14 within a social network 12 (e.g., by including in the notification 30 a contact identifier 56 of the contact 16). The instructions are also configured to present 82 the presentation 54 of the content source 24 to the user 14. In this manner, the exemplary method 70 achieves the notification of the user 14 of content items 26 hosted by the content source 16 and shared by a particular contact 16 within the social network 12 in accordance with the techniques herein (in particular, as the device 42 in the exemplary scenario 50 of FIG. 3 or as the client 64 in the exemplary scenario 70 of FIG. 4), and so ends at 84.

FIG. 6 presents a second embodiment of these techniques, illustrated as an exemplary system 96 operating on a device 92 having a processor 94, where the device 92 is configured to notify a user 14 of content items 26 shared by a contact 16 within a social network 12. The exemplary system 96 may be implemented, e.g., as a set of interoperating components that interoperate to perform the techniques presented herein. Each component of the exemplary system 96 may be implemented, e.g., as a set of software instructions stored in a memory component of a device 42, such as a system memory circuit, a platter of a hard disk drive, a solid-state storage device, or a magnetic or optical disc; as one or more hardware components, e.g., a circuit or a field-programmable gate array (FPGA) programmed to perform a particular element of these techniques; or a combination thereof. The exemplary system 96 includes a content item receiving component 98, which is configured to, upon receiving from the user 14 a request for a presentation 54 of a content source 24, receive shared content items 26 that are hosted by the content source 24 that have been shared with the user 14 within the social network 12 (possibly including the comments 28 associated with such content items 26). The exemplary system 96 also includes a content source presenting component 100, which is configured to, upon receiving from the user 14 a request 52 for a presentation 54 of the content source 24, generate a presentation 54 of the content source 24 including at least one notification 30 of a content item 26 shared with the user 14 and identifying the contact 16 sharing the content item 26 with the user 14 within a social network 12 (e.g., by including in the notification 30 a contact identifier 56 of the contact 16). The content source presenting component 100 is also configured to present the presentation 54 of the content source 24 to the user 14. In this manner, the exemplary system 96 of FIG. 5 achieves the notification of the user 14 of content items 26 hosted by the content source 16 and shared by a particular contact 16 within the social network 12, in accordance with the techniques herein (in particular, as the device 42 in the exemplary scenario 50 of FIG. 3 or as the client 64 in the exemplary scenario 70 of FIG. 4).

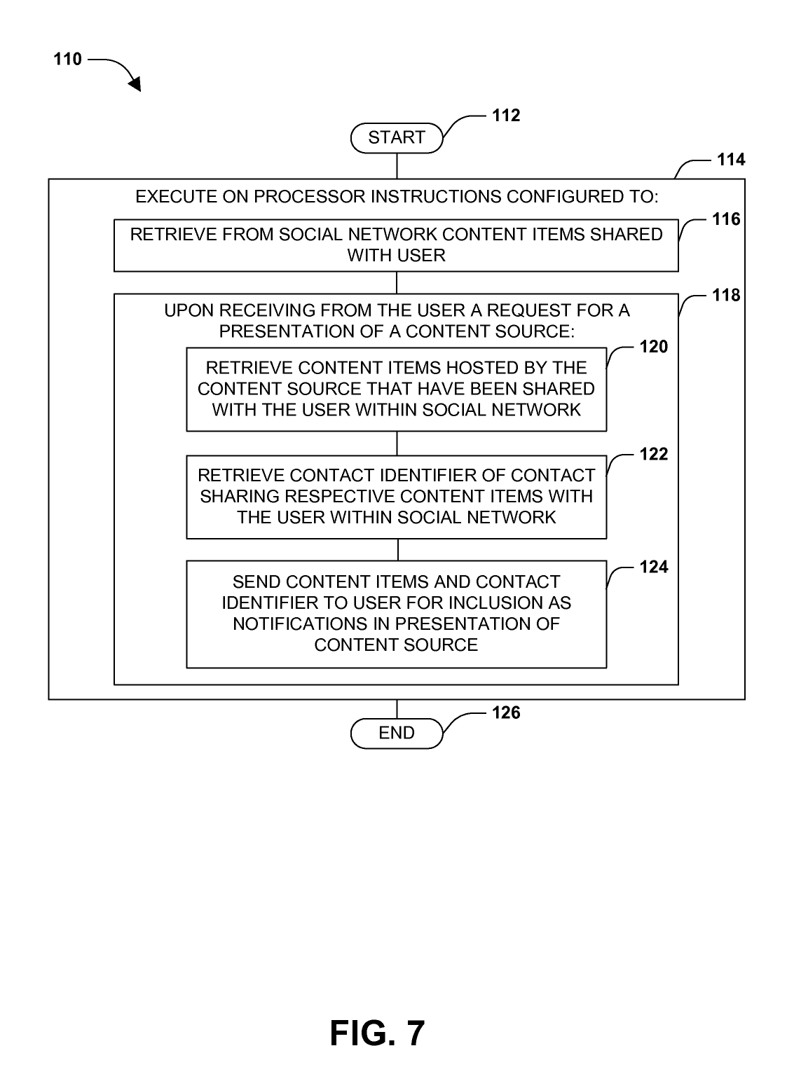

FIG. 7 presents a third embodiment of these techniques, illustrated as another exemplary method 110 of notifying a user 14 of content items 26 shared by a contact 16 within a social network 12. This exemplary method 110 may be implemented, e.g., as a set of software instructions stored in a memory component of a device 42 (e.g., a content item server 62), such as a system memory circuit, a platter of a hard disk drive, a solid-state storage device, or a magnetic or optical disc, where such instructions are configured to implement the techniques presented herein. The exemplary method 110 begins at 112 and involves executing 114 the instructions on a processor 94 of the device 42. In particular, the instructions are configured to retrieve 116 from the social network 12 the content items 26 shared with the user 14 (possibly including the comments 28 associated with such content items 26). The instructions are also configured to, upon receiving 118 from the user 14 a request 52 for a presentation 54 of a content source 24, retrieve 120 the content items 26 hosted by the content source 24 that have been shared with the user 14 within the social network 12, and retrieve 122 a contact identifiers 58 of contacts 16 sharing respective content items 26 with the user 14 within a social network 12. The instructions are also configured to send 124 the content items 26 and the contact identifier(s) 56 to the user 14 (e.g., to a client 64 operated by the user 14) for inclusion as notifications 30 of the shared content items 26 in the presentation 54 of the content source 24. In this manner, the exemplary method 110 achieves the notification of the user 14 of content items 26 hosted by the content source 16 and shared by a particular contact 16 within the social network 12 in accordance with the techniques herein (in particular, as the content item server 62 in the exemplary scenario 70 of FIG. 4), and so ends at 124.

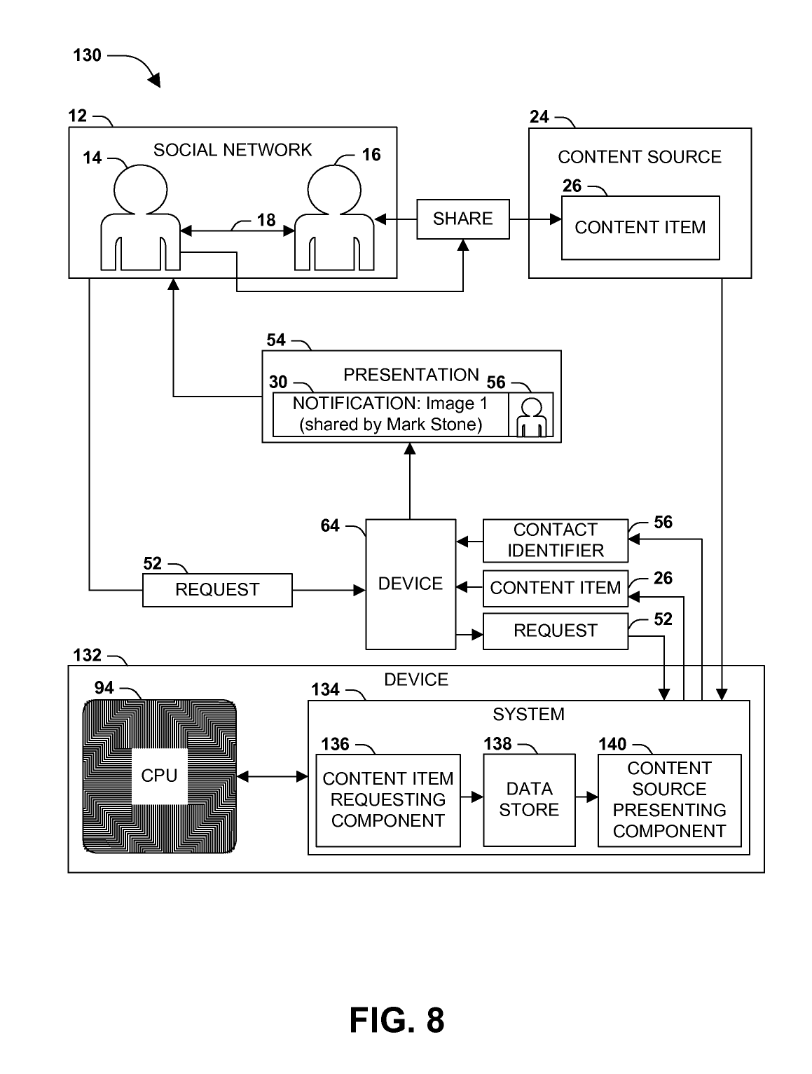

FIG. 8 presents a fourth embodiment of these techniques, illustrated as an exemplary system 134 operating on a device 132 having a processor 94, where the device 132 is configured to notify a user 14 of content items 26 shared by a contact 16 within a social network 12. The exemplary system 134 may be implemented, e.g., as a set of interoperating components that interoperate to perform the techniques presented herein. Each component of the exemplary system 96 may be implemented, e.g., as a set of software instructions stored in a memory component of a device 42, such as a system memory circuit, a platter of a hard disk drive, a solid-state storage device, or a magnetic or optical disc; as one or more hardware components, e.g., a circuit or a field-programmable gate array (FPGA) programmed to perform a particular element of these techniques; or a combination thereof. The exemplary system 134 includes a data store 138 that is configured to store the content items 136 (e.g., in the form of the content item data set 44 and possibly the comment data set 46 illustrated in the exemplary scenario 40 of FIG. 2). The exemplary system 134 also includes a content item requesting component 136, which is configured to retrieve from the social network 12 the content items 26 (possibly including the comments 28 thereto) shared with the user 14, and to store the content items 26 in the data store 138. The exemplary system 134 also includes a content source presenting component 140, which is configured to, upon receiving from the user 14 a request 52 for a presentation 54 of a content source 24, retrieve from the data store 138 the content items 26 hosted by the content source 24 that have been shared with the user 14 within the social network 12, and send the content items 26 to the user 14 (e.g., to a client 64 operated by the user 14) for inclusion as notifications 30 of shared content items 26 in the presentation 54 of the content source 24. In this manner, the exemplary system 134 achieves the notification of the user 14 of content items 26 hosted by the content source 16 and shared by a particular contact 16 within the social network 12 in accordance with the techniques herein (in particular, as the content item server 62 in the exemplary scenario 70 of FIG. 4).

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

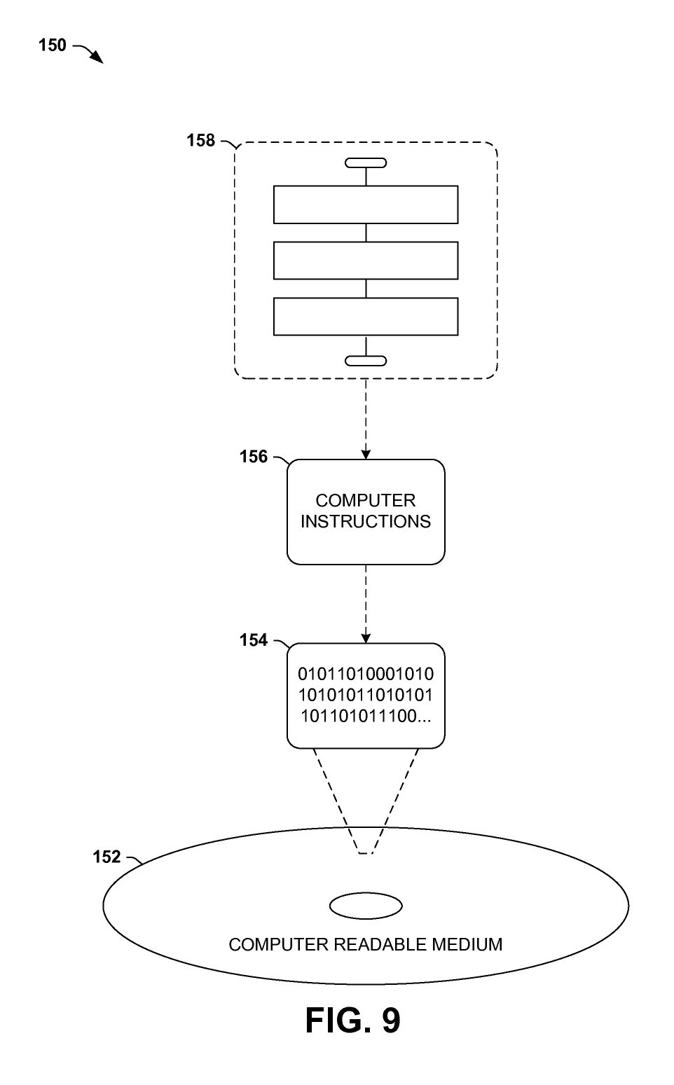

An exemplary computer-readable storage medium that may be devised in these ways is illustrated in FIG. 9, wherein the implementation 150 comprises a computer-readable medium 152 (e.g., a CD-R, DVD-R, or a platter of a hard disk drive), on which is encoded computer-readable data 154. This computer-readable data 154 in turn comprises a set of computer instructions 156 configured to operate according to the principles set forth herein. In one such embodiment, the processor-executable instructions 156 may be configured to perform a method of notifying a user 14 of content items 26 shared by a contact 16 within a social network 12, such as the exemplary method 70 of FIG. 5 and/or the exemplary method 110 of FIG. 7. In another such embodiment, the processor-executable instructions 156 may be configured to implement a system configured to notify a user 14 of content items 26 shared by a contact 16 within a social network 12, such as the exemplary system 92 of FIG. 6 or the exemplary system 134 of FIG. 8. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 70 of FIG. 5, the exemplary system 92 of FIG. 6, the exemplary method 110 of FIG. 7, and/or the exemplary system 134 of FIG. 8) to confer individual and/or synergistic advantages upon such embodiments.

A first aspect that may vary among embodiments of these techniques relates to the scenarios wherein such techniques may be utilized. As a first example, these techniques may be applied to many types of social networks 12, including social networks representing real-world relationships such as familial relations and friendships; academic social networks representing connections among students and teachers; professional social networks representing professional associations among colleagues; and themed social networks representing connections among users 14 sharing an interest, such as participants in an online game. Additionally, an embodiment of these techniques may monitor a plurality of social networks 12, since a user 14 may have established social profiles on several such social networks 12 (e.g., a first social network 12 comprising a genealogy network involving familial relationships 18; a second social network 12 comprising a friendship network involving friend relationships 18; a third social network 12 comprising a professional network involving academic and colleague relationships 18; and a fourth social network 12 comprising an activity-oriented network for members of a shared activity, such as participation in an online game). The embodiment may also monitor such social networks 12 on behalf of a plurality of users 14 represented therein, and possibly scaling up to a large number of users 14 or even an entire population of one or more social networks 12.

As a second example of this first aspect, these techniques may be utilized to present users 14 with many types of content items 26, such as web pages hosted by a website, images hosted by an image database, audio or video recordings hosted by an audio or video sharing service, and files hosted by a file server. The content item 26 may also include a comment 28 related thereto, and/or one or more metadata items describing the sharing of the content item 26 and/or one or more comments 28, such as a title of the shared content item 26 or a date of the sharing of the content item 26 or authoring of the comment 28.

As a third example of this first aspect, a user 14 of a social network 12 may share a content item 26 with a contact 16 of the user 14 within the social network 12 in many ways. For example, a user 14 may submit a public status message that is not directed to any contact 16, but that is viewable by some or all contacts 16 of the user 14; a public or private message to a user 14, such as a private or public dialogue between the user 14 and one or more contacts 16; or a chat message in a realtime chat environment. Those of ordinary skill in the art may devise many scenarios wherein the techniques presented herein may be utilized.

A second aspect that may vary among embodiments of these techniques relates to the identification relates to the presentation of a notification 30 of a content item 26 shared with the user 14 by a contact 16 within a social network 12. As a first example of this second aspect, notifications 30 of shared content items 26 may be included in a presentation 54 of a content source 24 in many ways. As a first such example, the notifications 30 may be interleaved with other content items 26, e.g., by interleaving the notifications 30 with search results of a search performed by the user 14 for content items 26 hosted by the content source 24. As a second such example, the notifications 30 may be distinctively presented, e.g., by including notifications 30 in a designated area of the presentation 54, and/or by presenting the notifications 30 with a different visual style.

As a second example of this second aspect, an embodiment of these techniques may, among the content items 26 hosted by the content source 24 and shared with the user 14 by a contact 16 within a social network 12, select one or more content items 26 for inclusion in the set of notifications 30. Among these content items 26, the embodiment may therefore select a subset of one or more selected shared content items, and may include in the presentation 54 of the content source 24 notifications 30 of the selected shared content items.

In accordance with this second example of this second aspect, an embodiment of these techniques may select among the content items 26 in many ways, e.g., based on one or more selectivity criteria (which may be represented, e.g., as a selectivity criteria set). As a first such example, the embodiment may utilize a relevance selectivity criterion, such as a relevance of a shared content item 26 with a content item 26 hosted by the same content source 24 and that the user 14 is currently viewing or has viewed. For example, if the user 14 is currently viewing or has recently viewed a particular content item 26 shared by the content source 24, an embodiment of these techniques may choose selected content items 26 among the set of shared content items 26 based on the relevance to the viewed content item 26. The relevance may be determined in many ways (e.g., identifying a similarity between the titles of the content items 26 or between the contents of the content items 26; or similarities in headers, attributes, or tags associated with the shared content item 26 and the viewed content item 26. As a second such example, the embodiment may utilize a social network selectivity criterion. For example, the user 14 may primarily use a first social network 12 and may secondarily use a second social network 12, and an embodiment may select for presentation as notifications 30 the content items 26 shared in the first social network 12 over those content items 26 shared in the second social network 12. As a third such example, the embodiment may utilize a content item type selectivity criterion, which may be associated with the content item types of respective content items 26. For example, the user 14 may be more interested in some types of content item 26 than others (e.g., images more than audio or video recordings), and an embodiment may select content items 26 for inclusion in the presentation 54 based on the content item types of the content items 26. As a fourth such example, the embodiment may utilize a contact selectivity criterion to select content items 26 (for inclusion as notifications 30) based on the contact 18 sharing the content item 26 with the user 14. For example, content items 26 received from family members may be more interesting to the user 12 than content items 26 received from friends, or favorite friends of the user 14 than more distantly related contacts 18. The embodiment may also permit a user 14 to specify that more or fewer content items 26 shared by a particular contact 18 are to be included in the set of notifications 30 included in the presentation 54 of one or more content sources 24.

Having selected one or more selectivity criteria from among the shared content items 26 hosted by the content source 24, an embodiment of these techniques may apply these selectivity criteria in various ways. As a first such example, the selectivity criteria may be applied, e.g., by presenting notifications 30 of some content items 26 but not of other content items 26; by sorting the notifications 30 of the content items 26 to present content items 26 of higher predicted interest to the user 14 before other content items 26 of lower predicted interest to the user 14; by presenting a first set of content items 26 of higher predicted interest to the user 14, and only presenting the second set of content items 26 if the user 14 requests to view more content items 26; etc. As a second such example, the presentation 54 may include sufficient space for a particular number of notifications 30 of such shared content items 26, and an embodiment may select for notification 30 the shared content items 26 with comparatively high selectivity until the presentation 54 is full. As a third such example, an embodiment may score various shared content items 26 based on several selectivity criteria, and may include notifications 30 in the presentation 54 only for the shared content items 26 having the highest scores. Many such selectivity criteria may be selected and/or applied to alter the presentation 54 of notifications 30 of shared content items 26.

As a third example of this second aspect, within a notification 30 of a shared content item 26, the contact 16 who has shared the content item 26 with the user 14 may be identified and represented using many types of contact identifiers 56, such as a name, a nickname, a username, or another identifier of the contact 56 within the social network 14. The contact identifier 56 may also comprise a contact depiction that visually depicts the user 14, either in a literal manner (e.g., a photo or drawing of the contact 16) or in a virtual manner (e.g., an avatar representation of the contact 16, such as a symbol, icon, or cartoon character used to represent the contact 16 within the social network 12).

As a fourth example of this second aspect, a contact 16 may be represented within a notification 30 with a reference 22 (such as a uniform resource identifier (URI)) to a social profile of the contact 16 within a social network 12. By using the reference 22 (e.g., by clicking on a hyperlink associated with the URI), the user 14 may vie the social profile of the contact 16, e.g., in order to receive more information about the contact 16.

As a fifth example of this second aspect, the notifications 30 of the sharing of content items 26 may be presented in various ways. In a first such example, the user 14 may have a social profile within two or more social networks 12, and an embodiment of these techniques may aggregate the content items 26 shared with the user 14 within several social networks 12. Accordingly, for a particular content source 32, the presentation 54 of a particular content source 24 may include notifications 30 of content items 26 hosted by the content source 24 and shared with the user 14 by the contacts 16 of several social networks 12, regardless of the social network 12 within which the sharing occurred. In a second such example, a content item 26 may have been redundantly shared with the user 14, e.g., by a first contact 16 within a social network 12 and by a second contact 16 within the same or another social network 12. This redundant sharing may involve multiple references 22 to the same content item 26 hosted by the same content source 24; references 22 to multiple, equivalent versions of the same content item 26 (e.g., to two identical copies of an image hosted in an image database); or to references 22 to the same content item 26 hosted by different content sources 24. In order to avoid notifying the user 14 redundantly of the sharing of the same content item 26, an embodiment may be configured to reduce redundant notifications 30 by aggregating the notifications 30 for the content item 26. For example, instead of generating a first notification 30 of a first sharing of a content item 26 (“Mark Stone shared Image 15 with you”) and a second notification 30 of a second sharing of the same content item 26 (“Nancy Baker shared Image 15 with you”), these redundant notifications 30 may be aggregated into a single notification 30 (e.g., “Mark Stone and Nancy Baker shared Image 15 with you”).

As a sixth example of this second aspect, the set of notifications 30 may be processed in many ways prior to being presented to the user 14. As a first such example, the content source presenting component 16 may sort the notifications 30 of content items 26 according to the contact 16 sharing the content item 26 with the user 14. For example, the presentation 54 may group the notifications 30 based on the contact 16 sharing the content item 26, and may sort the groups of notifications 30 according to the contacts 16 (e.g., according to the number of notifications 30 shared by each contact 16, according to the alphabetic order of the names of the contacts 16, or according to the proximity of the relationship 18 of the contact 16 to the user 14). In one such scenario, if respective contacts 16 associated with at least one contact group (e.g., a “Friends” social group, a “Colleagues” social group, and an “Other Acquaintances” social group), the sorting may be performed according to the contact group of the contact sharing the content item with the user 14 (e.g., “Content Items Shared by Friends” group of notifications 30, a “Content Items Shared by Colleagues” group of notifications 30, and a “Content Items Shared by Other Acquaintances” group of notifications 30). In another such scenario, if at least one contact 16 has social profiles in multiple social networks 12 (e.g., a first social profile in a first social network 12 and a second social profile in a second social network 12) and shares content items 26 with the user 14 in several social networks 12, an embodiment may group the notifications 30 of content items 26 shared by the contact 16 while sorting the notifications 30 according to the contact 16 sharing the content item 26 with the user 14 (e.g., regardless of the social profile and/or social network 12 used by the contact 16 to share the content item 26 with the user 14). As a second such example, an embodiment of these techniques may filter the notifications 30 of content items 26 to those generated by a selected contact 16 or a selected contact group that is selected by the user 14 (such that only the content items 26 shared by the selected contact 16 or the selected contact group are to be included in the presentation of notifications 30). The embodiment may therefore generate the presentation 54 comprising only the notifications 30 of content items 26 shared by the selected contact 16 or selected contact group (e.g., by removing notifications 30 of other shared content items 16 shared by other contacts 16 or contact groups from the presentation 54).

As a seventh example of this second aspect, the presentation 54 of the content source 24 may be adjusted with respect to notifications 30 of content items 26 shared by the user 14. For example, the user 14 may have publicly posted a content item 26 within a social network 12 (e.g., in a personal status update), and the social network 12 may include the content item 26 within the set of content item 26 that have been shared with the user 14 within the social network 12. In a first such example, the user 14 may wish to see the entire set of recently shared content items 26 within the social network 12. The user 14 may also wish to utilize the notifications 30 as temporary bookmarks of content items 26 hosted by the content source 24 with which the user 14 has interacted. Accordingly, it may be desirable for an embodiment of these techniques to include the notifications 30 of content items 26 shared by the user 14 in the presentation 54. Conversely, the user 14 may not wish to see notifications 30 of the content items 26 shared by the user 14, but may only wish to see notifications 30 of content items 26 shared with the user 14 by a contact 16 within the social network 12 (e.g., in order to limit the set of notifications 30 to those for content items 26 that the user 14 has not previously seen). Accordingly, it may be desirable for an embodiment of these techniques to exclude the notifications 30 of content items 26 shared by the user 14 in the presentation 54.

As a eighth example of this second aspect, respective notifications 30 may represent a content item 26 in various ways. As a first such example, a notification 30 may simply inform the user 14 of a shared content item 26 (e.g., “Nancy Baker has shared a content item with you; click here to view the content item”), or may simply describe the content item 26 without providing a hyperlink (e.g., “Nancy Baker has shared a content item hosted by this content source named ‘Image 16’”). A plain description of the shared content items 26 may be suitable, e.g., for a notification 30 comprising an entry in a Real Simple Subscription (RSS) news feed (although, in contrast with conventional news feeds, the notifications 30 of the techniques presented herein relate to the content source 24 presented to the user 14). However, it may be advantageous to improve the representation of the content item 16 within the notification 30. As a second such example, the notification 30 may include a reference 22 that may be utilized to access the content item 26, such as a uniform resource identifier (URI) depicted as a hyperlink that, when activated by the user 14, results in a presentation of the content item 26 represented by the notification 30. Alternatively or additionally, a notification 30 may include a content item representation, such as one or more portions of the content item 26 (e.g., a title of a document or a first image in an image series) and/or a preview version of the content item (e.g., a thumbnail version of an image that is downscaled to a smaller size and a lower resolution).

As a ninth example of this second aspect, the presentation 54 of notifications 30 may be adjusted in view of the time of the presentation 54 and the respective times of the notifications 30. As one such example, it may be desirable to present a set of notifications 30 that have not been presented before. One such embodiment may be configured to include in each presentation 54 of a content source 24 only notifications 30 of content items 26 that have been shared with the user 14 since a previous presentation 54 of the content source 24. For example, upon generating a first presentation 54 of the content source 24, an embodiment may store (e.g., in the data store 138) a latest presentation time of the content source 24; and upon receiving a request 52 to generate a second presentation 54 of the content source 24, the embodiment may retrieve the latest presentation time of the content source 24, and may generate a presentation 54 of the content source 24 comprising notifications 30 of content items 26 that have been shared with the user 14 after the latest presentation time of the content source 24. This variation may promote the freshness of the notifications 30 (e.g., by not presenting to the user 14 notifications 30 that were also included in a previous presentation 54 of the content source 54). Alternatively or additionally, a presentation 54 of a content source 24 may be supplemented with notifications 30 of content items 26 shared with the user 14 while the user 14 is viewing a presentation 54 of the content source 24, e.g., after the presentation 54 has been generated. For example, a system embodiment (such as the exemplary system 96 of FIG. 6 or the exemplary system 134 of FIG. 8) may include a content item updating component, which may be configured to, upon receiving from a social network 12 a shared content item 26 that has been shared with the user 14 while presenting to the user 14 the content source 24 hosting the shared content item 26, supplement the presentation 54 of the content source 24 with a notification 30 of the shared content item 26. Various technologies (such as push technologies) and/or protocols (such as Asynchronous JavaScript and XML (AJAX)) may be utilized to achieve the updating of a presentation 54 such as a web page. Those of ordinary skill in the art may devise many ways of presenting notifications 30 of shared content items 26 and representing the contact 16 sharing the content item 26 with the user 14 while implementing the techniques presented herein.

A third aspect that may vary among embodiments of these techniques relates to additional actions that an embodiment may permit a user 14 to perform in relation to a notification 30 of a content items 26 shared by a contact 16 within a social network 12. These additional actions may be provided by the content source 24 (e.g., by adding support for the actions into web pages rendered by the content source 24) and/or may inserted into the presentation 54 of the content source 24 by a device operated by the user 14 (e.g., a client 64 operating within the device of the user 14).

As a first example of this third aspect, in addition to viewing information about the contact 16 (such as a social profile of the contact 16), the embodiment may permit the user 14 to view additional content items 26 that are hosted by the content source 24 and that have been shared by the contact 16. For example, a contact 16 may have shared with the user 14 many content items 26 hosted by the content source 24, but only notifications 30 of recently shared content items 26 may be included in a presentation 54. The presentation 54 may therefore allow a user 14, to whom a presentation 54 including a notification 30 of a content item 16 recently shared by a contact 16 within a social network 12, to request to view all content items 26 hosted by the content source 24 and shared with the user 14 by the contact 16, regardless of the date of sharing.

As a second example of this third aspect, a presentation 54 to a user 14 of notifications 30 of shared content items 26 may permit the user 14 to communicate with the contacts 16 sharing the content items 26. In a first such example, a system embodiment of these techniques (such as the exemplary system 96 of FIG. 6 or the exemplary system 134 of FIG. 8) may include a contact messaging component, which may be configured to, upon receiving from the user 14 a request to send a message to a contact 16 identified in a notification 30 of the presentation 54, send the message to a social network 12 for delivery to the contact 16. In a second such example, a system embodiment of these techniques (such as the exemplary system 96 of FIG. 6 or the exemplary system 134 of FIG. 8) may include a contact chat initiating component, which may be configured to, upon receiving from the user 14 a request to initiate a chat (such as an instant messaging discussion) with a contact 16 identified in a notification 30 of the presentation, initiate a chat with the contact 16. In particular, it may be advantageous to initiate the chat with the contact 16 within a notification region of the presentation 4 where the notifications 30 are presented. Those of ordinary skill in the art may devise many additional actions that may be included in a presentation 54 of notifications 30 of content items 26 shared with a user 14 by a contact 16 within a social network 12 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

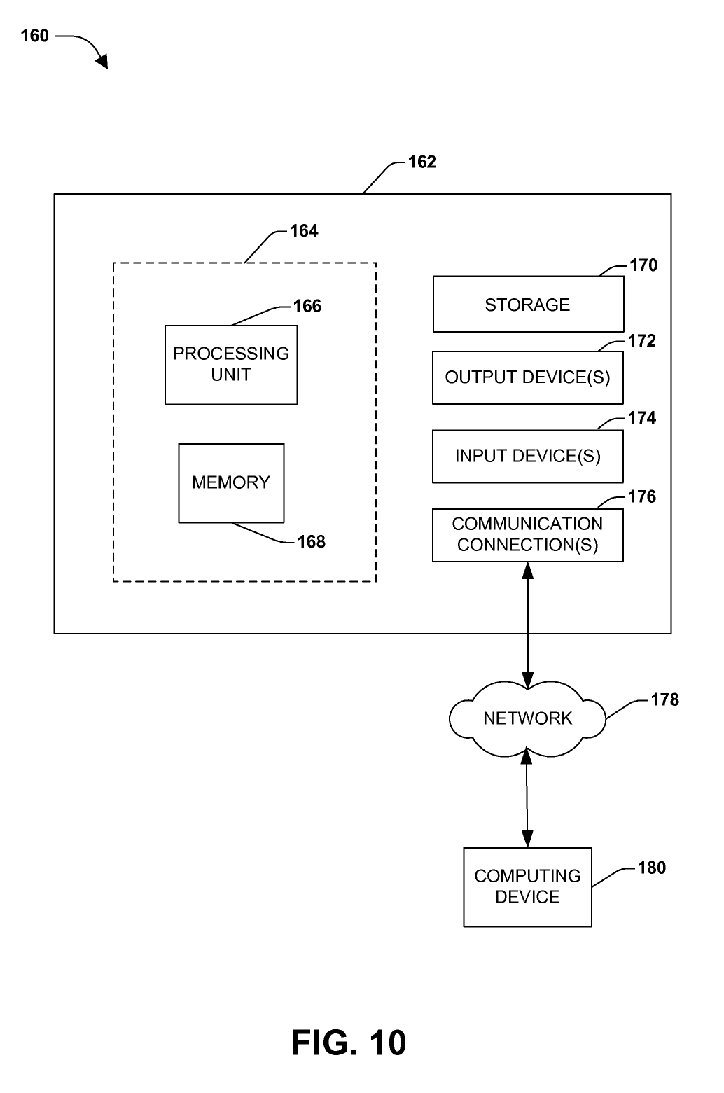

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 10 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 10 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system configured to notify a user of content items hosted by a content source shared with the user by a contact within a social network, the system comprising:
a content item receiving component configured to receive from a social network a content item hosted by a content source and shared with a user by a contact, store a notification of the content item; and
a content source presenting component configured to, upon receiving from the user a request for a presentation of a content source:
generate a presentation of the content source including at least one notification of a shared content items hosted by the content source and identifying the contact sharing the content item with the user; and
present the presentation of the content source to the user.

2. The system of claim 1, the content source presenting component configured to:
select at least one selected shared content item from the content items hosted by the content source and shared with the user by a contact within a social network, and
generate the presentation of the content source including at least one notification of at least one selected shared content item.

3. The system of claim 1, the content source presenting component configured to select selected shared content items from the shared content items using at least one selectivity criterion selected from a selectivity criteria set comprising:
a relevance selectivity criterion associated with a relevance of the shared content item to a content item hosted by the content source and viewed by the user;
a social network selectivity criterion associated with the social network within which the content item was shared with the user;
a content item type selectivity criterion associated with a content item type of the content item; and
a contact selectivity criterion associated with the contact sharing the contact item with the user.

4. The system of claim 1:
respective contacts associated with a contact depiction; and
the content source presenting component configured to identify, within the notification of a content item, the contact sharing the content item with the user using a contact depiction of the contact.

5. The system of claim 1:
at least one content item shared with the user by a first contact and a second contact; and
the content source presenting component configured to generate a presentation of the content source aggregating notifications of the content item shared by the first contact and the second contact.

6. The system of claim 1, the content source presenting component configured to sort the notifications of content items according to the contact sharing the content item with the user.

7. The system of claim 6:
at least one contact having a first social profile within a first social network and a second social profile within a second social network; and
the content source presenting component configured to, while sorting the notifications of content items according to the contact sharing the content item with the user, group the content items shared by the first social profile and the second social profile.

8. The system of claim 1, the content source presenting component configured to:
receive from a user at least one selected contact whose content items are to be included in the presentation of notifications, and
generate the presentation of the content source including notifications of shared content items hosted by the content source and shared by the at least one selected contact.

9. The system of claim 1, the content source presenting component configured to include in the notifications content items shared by the user within the social network.

10. The system of claim 1, the content source presenting component configured to exclude from the notifications content items shared by the user within the social network.

11. The system of claim 1, the content source presenting component configured to generate a presentation of the content source including with the notification a content item representation of the content item.

12. The system of claim 1, the content source presenting component configured to:
upon generating a first presentation of the content source, store a latest presentation time of the content source; and
upon receiving a request to generate a second presentation of the content source:
retrieve the latest presentation time of the content source, and
generate a presentation of the content source comprising notifications of content items that have been shared with the user after the latest presentation time of the content source.

13. The system of claim 1, comprising: a content item updating component configured to, upon receiving from a social network a shared content item hosted by a content source while presenting the content source to the user, supplement the presentation of the content source with a notification of the shared content item.

14. The system of claim 1:
respective contacts associated with at least one social profile; and
the content source presenting component configured to generate a presentation of the content source including at least one reference to a social profile of the contact sharing the content item with the user.

15. The system of claim 1, the content source presenting component configured to, upon receiving a request to identify content items hosted by the content source and shared by a contact:
identify the shared content items hosted by the content source, and
present the shared content items to the user.

16. The system of claim 1, comprising: a contact messaging component configured to, upon receiving from the user a request to send a message to a contact identified in a notification of the presentation, send the message to a social network for delivery to the contact.

17. The system of claim 1, comprising: a contact chat initiating component configured to, upon receiving from the user a request to initiate a chat with a contact identified in a notification of the presentation, initiate a chat with the contact.

18. The system of claim 17:
the notifications presented within a notification region of the presentation; and
the contact chat initiating component configured to initiate the chat with the contact within the notification region of the presentation.

19. A method of presenting to a user content items shared with the user within a social network, respective content items hosted by a content source, the method utilizing a device having a processor and comprising:
executing on the processor instructions configured to:
retrieve from the social network the content items shared with the user; and
upon receiving from the user a request for a presentation of a content source:
retrieve the content items hosted by the content source that have been shared with the user within the social network;
retrieve a contact identifier of the contact within the social network; and
send the content items to the user for inclusion as notifications in the presentation of the content source.

20. A computer-readable storage medium comprising instructions that, when executed on a processor of a device, implement components of a system configured to notify a user of content items hosted by a content source shared with the user by a contact within a social network, respective contacts associated with a contact depiction, and at least one contact having a first social profile within a first social network and a second social profile within a second social network, the system comprising:
a content item receiving component configured to receive from a social network a content item hosted by a content source and shared with a user by a contact, store a notification of the content item; and
a content source presenting component configured to, upon receiving from the user a request for a presentation of a content source:
retrieve a latest presentation time of the content source;
generate a presentation of the content source including, within a notification region of the presentation, at least one notification of a content items hosted by the content source and shared with the user by a contact after the latest presentation time of the content source, respective notifications identifying the contact sharing the content item with the user by using a contact depiction of the contact and including a content item representation of the content item and a reference to a social profile of the contact within a social network;
sort the notifications of content items according to the contact sharing the content item with the user, the sorting comprising, for contact having a first social profile within the first social network and a second social profile within a second social network, grouping the content items shared by the first social profile and the second social profile;
present the presentation of the content source to the user;
store a latest presentation time of the content source;
upon receiving a request to identify content items hosted by the content source and shared by a contact:
identify the shared content items hosted by the content source, and
present the shared content items to the user; and
upon receiving from a social network a shared content item hosted by a content source while presenting the content source to the user, supplement the presentation of the content source with a notification of the shared content item;
a contact messaging component configured to, upon receiving from the user a request to send a message to a contact identified in a notification of the presentation, send the message to a social network for delivery to the contact; and
a contact chat initiating component configured to, upon receiving from the user a request to initiate a chat with a contact identified in a notification of the presentation, initiate within the notification region of the presentation a chat with the contact.
